(19) United States
(12) Patent Application Publication
(10) Pub. No.: US 2010/0130187 A1
(43) Pub. Date: May 27, 2010

(54) BASE-STATION CONFIGURATION CONTROL SYSTEM AND METHOD

(75) Inventors: Bong Guk YU, Daejeon (KR); Sang Chul OH, Daejeon (KR); Hong Soog KIM, Daejeon (KR); Jung Sook BAE, Daejeon (KR); Dae Ho KIM, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics and Telecommunications Research Institute, Daejeon (KR)

(21) Appl. No.: 12/534,315

(22) Filed: Aug. 3, 2009

(30) Foreign Application Priority Data
Nov. 24, 2008 (KR) 10-2008-0116911

(51) Int. Cl. H04M 3/00

(52) U.S. Cl. 455/418

(57) ABSTRACT

Provided are a base-station configuration control apparatus, system and method. The base-station configuration control apparatus includes a user interface and a CPU. The user interface receives a user's request to selection of a standard protocol. The CPU receives one or more programs based on a selected standard protocol from a storage, which is connected to an external bus, to download the received programs to a function block through a host interface, based on a SDR technology.

### CROSS-REFERENCE TO RELATED APPLICATIONS

This application claims priority under 35 U.S.C. §119 to Korean Patent Application No. 10-2008-0116911, filed on Nov. 24, 2008, in the Korean Intellectual Property Office, the disclosure of which is incorporated herein by reference in its entirety.

### TECHNICAL FIELD

The following disclosure relates to a configuration control of a base station, and in particular, to a base-station configuration control system and method, which implement a base station based on a desired protocol by upgrading software.

### BACKGROUND

A related art mobile base station has supported only a specific protocol for a limited service. A next generation mobile communication standard, which is currently being standardized, recommends increasing service capacity and supporting various profiles.

Consequently, a base station for supporting the next generation mobile communication standard requires flexibility in order to reconfigure existing hardware with a profile for a new system. Efforts are being made to implement flexibility through a Software Defined Radio (SDR) technology that downloads the application software of an object-oriented structure to a hardware platform, in order to enable various communications.

In a related art configuration, however, because all software layers are mounted for each function block in a base station, the complexities and costs of hardware and software increase, and a reconfiguration process is also complicated.

### SUMMARY

In one aspect, a base-station configuration control apparatus includes: a user interface receiving a user's request to selection of a standard protocol; and a central processing unit (CPU) receiving one or more programs based on a selected standard protocol from a storage, which is connected to an external bus, to download the received programs to a function block through a host interface, based on a SDR technology.

In another aspect, a base-station configuration control system includes: a server storing one or more programs based on each standard protocol; and a base-station configuration control apparatus receiving the programs based on a selected standard protocol from the server, which is connected to an external bus, to download the received programs to a function block through a host interface, based on a SDR technology, wherein the base-station configuration control system configures a base station with the downloaded programs based on the selected standard protocol.

In other aspect, a base-station configuration control method includes: selecting a desired standard protocol among a plurality of standard protocols; receiving one or more programs based on the selected standard protocol through an external bus, based on a Software Defined Radio (SDR) technology; and downloading the received programs to a function block of a base station through a host interface.

Other features and aspects will be apparent from the following detailed description, the drawings, and the claims.

### BRIEF DESCRIPTION OF THE DRAWINGS

FIG. 1 is a block diagram illustrating a base-station configuration control apparatus according to an exemplary embodiment.

FIG. 2 is a block diagram illustrating a base-station configuration control system according to an exemplary embodiment.

FIG. 3 is a flowchart illustrating a base-station configuration control method according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skilled in the art. Also, descriptions of well-known functions and constructions may be omitted for increased clarity and conciseness.

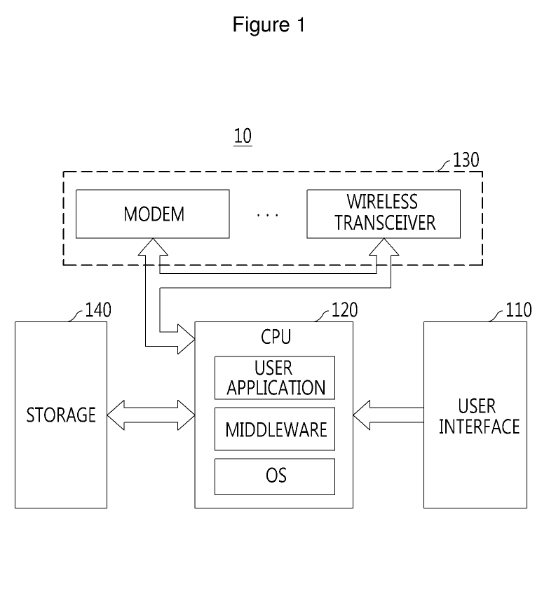

FIG. 1 is a block diagram illustrating a base-station configuration control apparatus according to an exemplary embodiment.

Referring to FIG. 1, a base-station configuration control apparatus 10 according to an exemplary embodiment includes a user interface 110 and a central processing unit (CPU) 120.

The user interface 110 receives a user's request to selection of a standard protocol. Herein, the user's request includes at least one of the download position of a program, authentication information and a communication system.

The standard protocol may be various wired/wireless communication protocols, for example, High Speed Downlink Packet Access (HSDPA), Worldwide Interoperability for Microwave Access (WiMAX), Code Division Multiple Access (CDMA) and Wideband Code Division Multiple Access (WCDMA).

The CPU 120 receives one or more programs based on a selected standard protocol among a plurality of programs based on each standard protocol which are stored in a storage 140 and downloads the received programs to a function block 130 included in a base station.

The CPU 120 includes a middleware, an operating system (OS) and a user application. The middleware provides a flexible integrated environment for downloading a program to the function block 130. The OS downloads a program received from the storage 140 to the function block 130 in the integrated environment which is provided from the middleware. The user application is the client program of the middleware, and may be used for setting change or operation and maintenance based on a user's request. The OS may be a Real Time Operating System (RTOS).

The function block 130 of the base station may be reconfigured with the downloaded program according to the selected standard protocol. The function block 130 includes an L3/L2 board, a modem for modulating/demodulating a signal, and a wireless transceiver for processing a wireless signal. The RF transceiver includes at least one of a digital Intermediate Frequency (IF) transceiver for processing and IF signal and a Radio Frequency (RF) transceiver for processing an RF signal.

The storage 140 may be a large-capacity storage or an Internet server, for storing a plurality of standard protocol-based programs and a plurality of new version programs. If the storage 140 is the large-capacity storage, it may be connected to the CPU 120 through a parallel bus. If the storage 140 is the Internet server, it may be connected to the CPU 120 through a bus for Internet Protocol (IP) communication.

As described above, the base-station configuration control apparatus 10 designs programs according to standard protocols to pre-store the designed programs in the storage 140. The CPU 120 receives the program based on the standard protocol from the storage 140 to download the received program to the function block 130. Thus the base-station configuration control apparatus 10 may reconfigure an existing base station as a base station based on a desired standard protocol even without changing the function block 130 in hardware. In addition, because a program is downloaded through the CPU 120, the function block 130 need not separately include an OS, a middleware and user application layers.

The following description will be made on a base-station configuration control system including the base-station configuration control apparatus corresponding to the CPU 120 in FIG. 1.

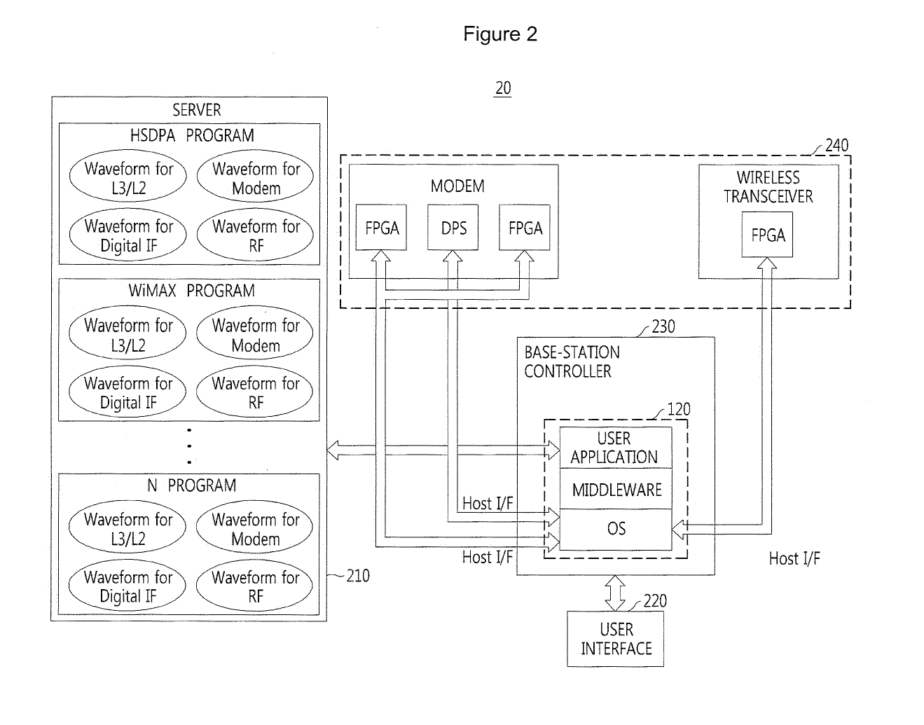

FIG. 2 is a block diagram illustrating a base-station configuration control system according to an exemplary embodiment.

Referring to FIG. 2, a base-station configuration control system 20 according to an exemplary embodiment includes a server 210, a user interface 220, a base-station configuration controller 230 and a function block 240.

The server 210 may be an external server which is connected to the base-station configuration controller 230 through an external bus such as an interface for IP communication.

The server 210 stores new version of programs which corresponding to each standard protocol. The standard protocols may be various wired/wireless communication protocols, for example, HSDPA, WiMAX, CDMA and WCDMA.

The programs include at least one of a user application, a middleware, a firmware and an OS for configuring a base station based on each standard protocol. The programs based on the each standard protocol may be managed for each version.

The user interface 220 receives a user's request to at least one of a desired standard protocol, the download position of a program, authentication information and a communication system and transfers the received request to the base-station configuration controller 230.

The base-station configuration controller 230 receives a program based on a standard protocol, which is selected according to a user's request and downloads from the server 210 to the function block 240. Specifically, the middleware of the base-station configuration controller 230 sets a flexible integrated environment for downloading the program from the server 210. The OS of the base-station configuration controller 230 downloads the program based on the selected standard protocol (which is received from the server 210) to the function block 240 through a host interface (Host I/F), in the set flexible integrated environment. At this point, the host interface may be at least one of a Host Parallel Interface (HPI) and a Joint Test Action Group (JTAG) Interface.

The function block 240 performs signal analysis, signal processing and signal transmission/reception necessary for the communication of the base station. The function block 240 includes at least one of an L3/L2 board, a modem, and a wireless transceiver.

Each of the function block 240 includes at least one of a Field Programmable Gate Array (FPGA) and a Digital Signal Processor (DSP). The function block 240 may store a program, which is downloaded from the base-station configuration controller 230, in the read-only memory (ROM) of the FPGA or the DSP and thereby perform a base-station operation according to a selected standard protocol.

According to an exemplary embodiment, the base-station configuration control system 20 upgrades software for controlling the base station even without changing hardware, thereby allowing the base station to support various standard protocols.

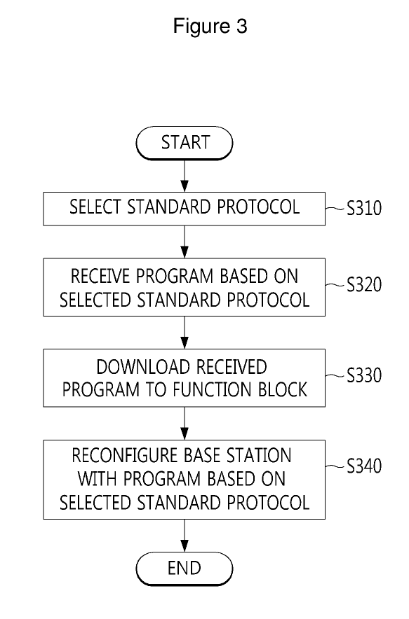

Hereinafter, a base-station configuration control method in the base-station configuration controller 230 of FIG. 2 will be described in detail with reference to FIG. 3.

FIG. 3 is a flowchart illustrating a base-station configuration control method according to an exemplary embodiment.

Referring to FIG. 3, the base-station configuration controller 230 selects a desired standard protocol among a plurality of standard protocols according to a user's request which is inputted through the user interface 220 in operation S310. Herein, the base-station configuration controller 230 pre-stores programs based on the plurality of standard protocols to use the stored programs in controlling base-station configuration. At this point, the base-station configuration controller 230 checks whether the selected standard protocol is the same as an existing used standard protocol. When the selected standard protocol is the same as the existing used standard protocol, the base-station configuration controller 230 does not perform the following base-station configuration control process by ignoring the user's request. On the other hand, when the selected standard protocol is not the same as the existing used standard protocol, the base-station configuration controller 230 performs the following base-station configuration control process, in order to allow the base station to operate according to the selected standard protocol.

The base-station configuration controller 230 receives a program based on the selected standard protocol from the server 210 in operation S320. At this point, the base-station configuration controller 230 may search programs in the server 210 to receive the searched programs based on the selected standard protocol from the server 210.

The base-station configuration controller 230 downloads programs, which are received through the host interface, to each of the function block 240 of the base station. The host interface may be at least one of the HPI and the JTAG Interface.

The function block 240 of the base station is reconfigured with the downloaded program based on the selected standard protocol, allowing the base station to operate according to the selected standard protocol in operation S340.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A base-station configuration control apparatus, comprising:
a user interface receiving a user's request to selection of a standard protocol; and
a central processing unit (CPU) receiving one or more programs based on a selected standard protocol from a storage, which is connected to an external bus, to download the received programs to a function block through a host interface, based on a Software Defined Radio (SDR) technology.

2. The base-station configuration control apparatus of claim 1, wherein the function block reconfigures a base station with the downloaded programs based on the selected standard protocol.

3. The base-station configuration control apparatus of claim 1, wherein the storage comprises:
a large-scale storage storing a plurality of standard protocol-based programs and a plurality of new version programs; and
an Internet server storing a plurality of standard protocol-based programs and a plurality of new version programs.

4. The base-station configuration control apparatus of claim 1, wherein the user's request comprises at least one of a download position of the program, authentication information and a communication system.

5. The base-station configuration control apparatus of claim 1, wherein the function block comprises a modem modulating/demodulating a signal.

6. The base-station configuration control apparatus of claim 1, wherein the function block comprises at least one of a digital IF transceiver processing an intermediate frequency signal and an RF transceiver processing a radio frequency signal.

7. The base-station configuration control apparatus of claim 1, wherein the CPU comprises:
a middleware providing a flexible integrated environment for downloading the programs to the function block; and
an operating system (OS) downloading the programs, which are received from the storage, to the function block in the integrated environment which is provided by the middleware.

8. A base-station configuration control system, comprising:
a server storing one or more programs based on each standard protocol; and
a base-station configuration controller receiving the programs based on a selected standard protocol from the server, which is connected to an external bus, to download the received programs to a function block through a host interface, based on a Software Defined Radio (SDR) technology,
wherein the base-station configuration control system configures a base station with the downloaded programs based on the selected standard protocol.

9. The base-station configuration control system of claim 8, wherein the function block comprises at least one of:
an L3/L2 board operating according to any one of the downloaded programs based on the selected standard protocol;
a modem operating according to any one of the downloaded programs based on the selected standard protocol; and
a wireless transceiver operating according to any one of the downloaded programs based on the selected standard protocol.

10. The base-station configuration control system of claim 9, wherein the function block comprises at least one of a Field Programmable Gate Array (FPGA) chip and a Digital Signal Processor (DSP).

11. The base-station configuration control system of claim 9, wherein the base-station configuration controller comprises:
a middleware providing a flexible integrated environment for downloading the programs from the server; and
an operating system (OS) downloading the programs from the server to the function block through the host interface, in the integrated environment which is provided by the middleware

12. The base-station configuration control system of claim 11, wherein the host interface comprises at least one of a Host Parallel Interface (HPI) and a Joint Test Action Group (JTAG) Interface.

13. The base-station configuration control system of claim 8, further comprising a user interface receiving a user's request to at least one of a download position of the program, authentication information and a communication system.

14. A base-station configuration control method, comprising:
selecting a desired standard protocol among a plurality of standard protocols;
receiving one or more programs based on the selected standard protocol through an external bus, based on a Software Defined Radio (SDR) technology; and
downloading the received programs to a function block of a base station through a host interface.

15. The base-station configuration control method of claim 14, further comprising reconfiguring the base station with the downloaded programs based on the selected standard protocol.

16. The base-station configuration control method of claim 14, further comprising determining whether the selected standard protocol is the same as a standard protocol which is being currently used in the base station,
wherein when the selected standard protocol is the same as the standard protocol which is being currently used in the base station, the receiving of the received programs and the downloading of the received programs are not performed.

17. The base-station configuration control method of claim 14, wherein the receiving of one or more programs comprises:
searching the programs based on the selected standard protocol in a storage which is connected to the external bus; and
receiving the searched programs.

18. The base-station configuration control method of claim 14, wherein the downloading of the received programs comprises:
providing, by a middleware, a flexible integrated environment for downloading the programs; and
downloading, by an operating system (OS), the programs to the function block in the integrated environment which is provided by the middleware.

19. The base-station configuration control method of claim 14, wherein the host interface comprises at least one of a Host Parallel Interface (HPI) and a Joint Test Action Group (JTAG) Interface.

20. The base-station configuration control method of claim 14, wherein the function block comprises at least one of an L3/L2 board, a modem and a wireless transceiver.
